(19) United States
(12) Patent Application Publication
(10) Pub. No.: US 2006/0116146 A1
(43) Pub. Date: Jun. 1, 2006

(54) System and method for monitoring mobile units in a network

(76) Inventors: Allan Herrod, Mission Viejo, CA (US); James Fagioli, Holtsville, NY (US); Donald E. Schaefer, Wantagh, NY (US); Mark Orlassino, Centereach, NY (US)

Correspondence Address: INGRASSIA FISHER & LORENZ, P.C., 7150 E. CAMELBACK, STE. 325, SCOTTSDALE, AZ, 85251, US

(21) Appl. No.: 11/000,550

(22) Filed: Nov. 30, 2004

(51) Int. Cl. H04M 3/00; H04Q 7/20; H04B 7/00

(52) U.S. Cl. 455/515; 455/418; 455/461

(57) ABSTRACT

A wireless networking system includes a network appliance and at least one mobile device. The mobile device comprises an application module, a discriminating application programming interface (API) that is executable within the context of the application and configured to receive data related to execution of the application and to determine whether the data is of a type that is to be monitored, and a monitoring API that is executable within the context of the application and configured to extract the data if the discriminating API determines the data is of a type that is to be monitored. The mobile device further comprises a wireless agent configured to extract and transmit the monitored data to the network appliance.

### TECHNICAL FIELD

The present invention generally relates to systems for networking a plurality of mobile service units, and more particularly relates to monitoring applications executed in the mobile units.

### BACKGROUND

Wireless networks are deployed in retail, transportation, logistics, manufacturing, warehousing, and numerous other industries. Wireless networks often include several mobile units that are configured to carry out numerous transactions by executing suitable applications. Information that pertains to executed transactions can be immediately transmitted from the mobile device to a network appliance for review or further processing. Alternatively, the information can be stored on the mobile device and transmitted to the network appliance at a later time.

As mentioned previously, the mobile devices are typically configured to execute numerous applications. A worker that is assigned to a task using a mobile unit may find it difficult to learn to carry out the applications or to troubleshoot problems associated with executing the applications. The mobile units are often utilized in a place where a technical expert can not immediately assist a worker that is experiencing difficulty. The worker may consequently have difficulty describing problems that the worker is experiencing with a mobile unit when an expert is available to help.

Also, execution of an application by a mobile device can produce or be the product of important information that a business would find beneficial. As just one example, the frequency at which a transaction is executed using a mobile device is something that a business can reflect on when considering business efficiency and productivity. Since the mobile devices are sometimes used at a location that is not easily monitored, transaction frequency information can be difficult to obtain.

Accordingly, it is desirable to provide ways to accurately monitor performance of a mobile device in a wireless network. In addition, it is desirable to keep track of a plurality of applications executed by the mobile device and the manner in which the applications are executed. Furthermore, other desirable features and characteristics of the present invention will become apparent from the subsequent detailed description and the appended claims, taken in conjunction with the accompanying drawings and the foregoing technical field and background.

### BRIEF SUMMARY

A wireless networking system is provided, comprising a network appliance having an integrated wireless management system and a processor, and at least one mobile device. The mobile device comprises an application module, a discriminating application programming interface (API) that is executable within the context of the application and configured to receive data related to execution of the application and to determine whether the data is of a type that is to be monitored, and a monitoring API that is executable within the context of the application and configured to extract the data if the discriminating API determines the data is of a type that is to be monitored. The mobile device further comprises a wireless agent configured to extract and transmit the monitored data to the network appliance.

A method is also provided for monitoring an application in a mobile device that is a component of a wireless network. The method comprises the first step of sending data related to execution of an application to a discriminating application programming interface (API) that is a module executable within the context of the application, and is configured to determine whether the data is of a type that is to be monitored. The method further includes the step of monitoring data related to execution of the application, using a monitoring API that is a module executable within the context of the application, if the discriminating API determines that the data is of the type that is to be monitored.

A program product is also provided for monitoring an application in a mobile device that is a network component. The program product includes computer readable instructions stored on the mobile device. The computer readable instructions are executable to send data related to execution of the application to a discriminating application programming interface (API) that is a module executable within the context of the application, and is configured to determine whether the data is of a type that is to be monitored. The computer readable instructions are further executable to monitor the data, using a monitoring API that is a module executable within the context of the application, if the discriminating API determines that the data is of the type that is to be monitored.

### BRIEF DESCRIPTION OF THE DRAWINGS

The present invention will hereinafter be described in conjunction with the following drawing figures, wherein like numerals denote like elements, and

FIG. 1 is a diagram that generally illustrates a wireless network;

FIG. 2 is a block diagram that illustrates an exemplary mobile unit that is a component of a wireless network;

FIG. 3 is a block diagram that illustrates an exemplary communication path between network devices;

FIG. 4 is a block diagram that illustrates two information collection pathways between a wireless agent and an application in a mobile unit according to an embodiment of the invention; and

FIG. 5 is a flow chart that illustrates exemplary method for monitoring an application according to an embodiment of the invention.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

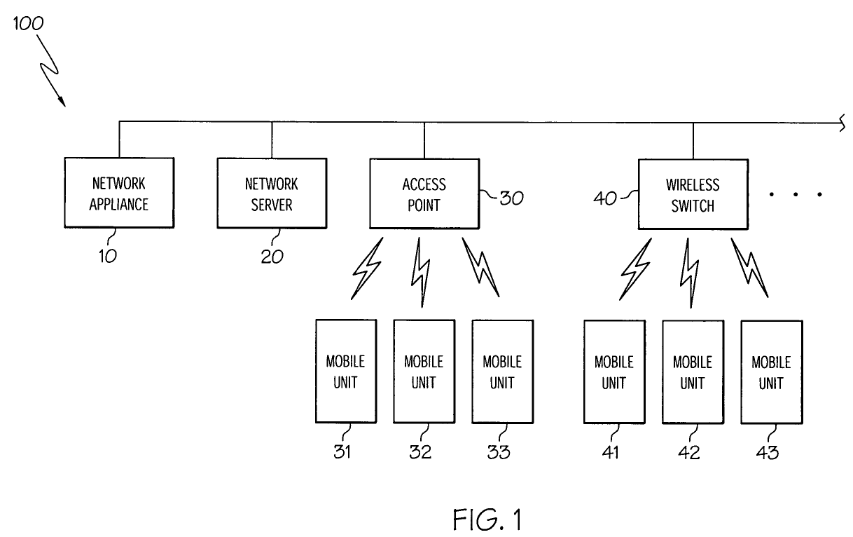

FIG. 1 is a general diagram illustrating an exemplary wireless network 100 that may implement an exemplary embodiment of the invention. The network 100 includes a network appliance 10, a network server 20, an access point 30 and a wireless switch 40. Each of the devices 10, 20, 30, 40 is shown as interconnected using a wired portion of the network 100. However, it is understood that the devices 10, 20, 30, 40 may also be wirelessly connected to the network 100. The network 100 may include any number of additional network components and/or devices not illustrated in FIG. 1.

A plurality of mobile units 31-33 are wirelessly connected to the network 100 by way of the access point 30. The mobile units 31-33 may be any type of computing or processor-based device including desktop or laptop computers, personal digital assistants, mobile phones, pagers, and scanners. The mobile units 31-33 and the access point 30 may operate within any type of wireless networking environment such as a wireless local area network (WLAN), and a wireless wide area network (WWAN). Communication between the mobile units 31-33 and the access point 30 may be accomplished using any wireless protocol such as IEEE 802.11, and Bluetooth. Similarly, mobile units 41-43 are wirelessly connected to the network 100 via the wireless switch 40. It is understand that the network 100 is only one exemplary embodiment that can be implemented in any wireless arrangement.

The following is a brief description of an exemplary operation of the network 100 in the context of a retail outlet having an on-site warehouse. This example provides a general description of exemplary interactions between the various network devices. The access point 30 is located in the retail space, and the mobile units 31-33 are portable check out devices used by clerks in the retail space. The wireless switch 40 is located in the warehouse space with the mobile units 41-43 being handheld computing devices used by the warehouse personnel.

According to the present embodiment, the network server 20 contains information about products that are sold by the retail outlet. The network server 20 is in contact with the mobile units 31-33 and 41-43 to keep the information current. For example, the network server may contain the current quantity of product A in the retail space and an inventory rule that states a minimum quantity for product A in the retail space. When a clerk uses a mobile unit 31 to identify a quantity of product A being purchased the mobile unit 31 transmits a message to the access point 30 indicating that the quantity of product A has been sold. The access point 30 then relays this message to the network server 20 that updates its records by removing that quantity from the current quantity of product in the retail space.

After updating its records, the network server 20 compares the current quantity to the minimum quantity from the inventory rule. If the current quantity is less than the minimum quantity, the network server 20 formats and sends a message to the mobile unit 31 via the wireless switch 40. The message indicates to the user of the mobile unit 31 that additional quantities of product A need to be moved from the warehouse to the retail space. The user of the mobile unit 31 sends an acknowledgment to the message after moving the additional quantity of product A from the warehouse to the retail space. The network server 20 then updates the information regarding the product A quantities in both the retail space and the warehouse space. Again, it, is understood that these network functions are only exemplary and are described to illustrate a set of issues that may be presented in just one setting that involves network control and management.

As mentioned previously, a network user at times will benefit from being able to diagnose and resolve network problems either locally or remotely. Additional benefits come from the ability to anticipate problems using the network and consequently to take steps to prevent the problems from occurring. Another exemplary embodiment includes wireless network management applications and associated appliances and modules that provide the network user with a complete end- to-end view of the network.

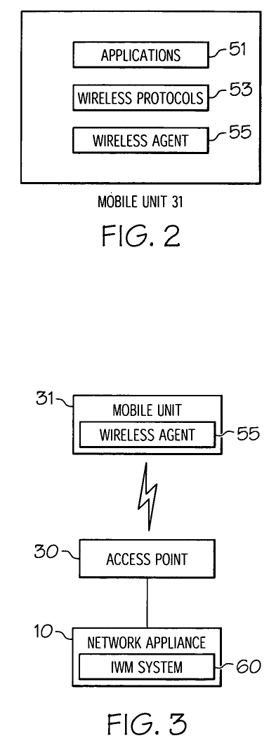

FIG. 2 is a block diagram that illustrates an exemplary mobile unit 31 from the network 100 described with reference to FIG. 1. The mobile unit 31 includes various software components including applications 51, wireless protocols 53 and a wireless agent 55. Other software components such as an operating system may also be included in the mobile unit 31. The applications 51 are software components that allow the mobile unit 31 to perform a desired function such as the check out application from the previous example. The wireless protocols 53 are software components that allow the mobile unit 31 to communicate with the access point 30 or other mobile units.

The wireless agent 55 is a software component that includes functionality for the integrated wireless device and network management system according to the present invention. The wireless agent 55 resides on each of the mobile units in the network 100 and collects information about the mobile unit 31 and its performance. The wireless agent 55 can receive inputs from a variety of sources within a mobile unit 31 in order to collect information. In one example, the wireless agent 55 monitors the battery level by either querying the operating system or receiving an input from the operating system to determine the current state of the battery life. In a further example the wireless agent 55 queries or receives an input from the wireless protocols 53 that indicates the current transmission bandwidth of the mobile unit 31. The wireless agent 55 is consequently the central information conduit in the mobile unit 31 for all the monitored attributes.

FIG. 3 is a block diagram that illustrates an exemplary communication path between network devices. In this example the communication path is between the mobile unit 31, the access point 30 and the network appliance 10. As previously described, the communication path operates bi-directionally so messages can be sent back and forth between the network appliance 10 and the mobile unit 31.

The network appliance 10 can include an integrated wireless management (IWM) system 60, the features and functionality of which will now be described in detail. According to an exemplary embodiment, the information that is collected by the wireless agent 55 is communicated to the IWM system 60 on the network appliance 10. The frequency of the transmitted information may vary based on the information that is being transmitted. For example, one of the monitored attributes can be the version of each software application 51 resident on the mobile unit 31, and such information may only need to be transmitted when there is a change in the version number. Information regarding other attributes such as battery level and transmission bandwidth typically changes more frequently and the wireless agent 55 can consequently transmit such information almost continuously to the IWM system 60.

The wireless agent 55 that is included in each device includes a set of policies to determine when attributes are transmitted to the IWM system 60. Each policy can indicate the specific attributes to be collected, such as current AC power line status, main battery level, main battery status, backup battery level, backup battery status, device IP address, device MAC address, DHCP server address, gateway address, network health, network state, memory load, free program memory, total program memory, free storage memory, and total storage memory. Policies can also indicate static information to be collected from the mobile device 31. Examples of static information include boot loader version, host name, OEM model, OEM version, OS build number, OS version, owner, platform OS model, and device unit identifier. Policies can also indicate system boot and performance information to be collected such as boot count, total device on seconds, CPU usage, performance measurement interval, performance samples, average thread latency, and average UI-thread latency. Policies can also indicate wireless association information such as wireless BSSID, wireless channel, wireless ESSID, and wireless association status. These are merely exemplary policies, and any number of policies can be implemented to indicate what type of information to collect, and the frequency for each collection.

In addition, mobile units 31-33 and 41-43 may only have intermittent connectivity to the network 100. Intermittent connectivity can be the result of various factors including use of the mobile unit out of range of its access point or wireless switch, bandwidth limitations, or loss of power to the mobile device. When a mobile unit 31 loses contact with the network 100 the wireless agent 55 can store the attributes in a buffer or other storage mechanism for later communication when the mobile unit 31 re-establishes connectivity with the network 100.

The IWM system 60 receives communications from the wireless agent 55 residing on a mobile unit 31 and stores information from the communication on the network appliance 10. The IWM system 60 stores the information for all the wireless devices on the network, including the mobile units 31-33 and 41-43, into a memory in the network appliance. A processor is also included in the network appliance 10 and can be configured to compile and present information to a user automatically or as prompted.

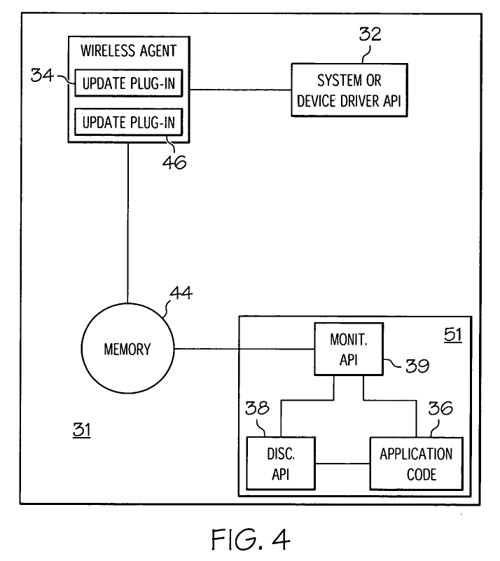

As previously mentioned, the wireless agent 55 is the central repository in a mobile unit 31 for all the mobile unit attributes that are monitored, and such attributes are determined from various data regarding the mobile device's status, health, and performance. FIG. 4 is a block diagram that illustrates two information collection pathways between the wireless agent 55 and an application 51 in a mobile unit 31. The application can be any module that executes a function for which monitoring is or may be desired. Exemplary applications include item shipping confirmations, item receipt confirmations, inventory checks, and price checks. Subsystems executing within the applications can also be monitored, each subsystem executing more specific functions and producing data pertaining to those functions. Exemplary subsystems include a bar code symbol reader module, a smart card reader module, a digital sensor module, a biometric sensor module, a magnetically encoded data reader module, an RFID reader module, and an optical code reader module.

In the first information collection pathway, for each set of information that is being monitored a system-level application programming interface (API) 32, such as a device driver API, delivers system-level information to the wireless agent 55. The wireless agent is configured, or supplemented with various plug-in modules 34, to collect and interpret information pertaining to the mobile unit 31 and to translate and communicate that and other information to and from the network appliance 10.

A significant characteristic of the first pathway is that global, process-independent information is delivered to the wireless agent 55. This is because the system-level API and the network appliance communicate in a process space that is separate from the applications 51 within the mobile unit. Even though summary information about application activities can be transferred to the wireless agent 55, the information is primarily system-level and does not report individual steps performed by modules executing within an application 51. There are numerous examples of attributes that may be collected by the wireless agent 55 including, but not limited to, battery level, available memory, receiving/transmission bandwidth, wireless signal attributes (e.g., signal quality, signal strength), and wireless throughput attributes (e.g., average link speed, bytes sent, bytes received, current link speed). It is understood that such attributes are only exemplary and that there are numerous other system-based attributes that may be collected for any given device using the first information collection pathway.

The device driver APIs and other system level APIs can also be configured to monitor more particular functions executed within an application using the first information pathway. Scanning attributes (e.g., number of good decodes, number of bad decodes, most recent scan, most recent scan length), and user authentication attributes (e.g., login count, login failures) are some exemplary functions that a bar code scanner applications execute, and these particular functions can be monitored using the first information collection pathway. However, process-independent hooks that facilitate this type of monitoring must be loaded as updates to the underlying device driver and system level APIs if this fine-scale monitoring is to be carried out, and updating in such a manner would be a relatively time consuming and burdensome process. Updating device drivers would require extensive testing prior to deployment. Further, changing a device driver or system level APIs carries the risk of destabilizing associated components.

A second information collection pathway enables monitoring of particular functions executed within an application, and an example of such a pathway is illustrated in FIG. 4. Information is collected in an exemplary embodiment by implementing a discriminating API 38 and a monitoring API 39 into the software for each application for which monitoring is or may be desired. More particularly, when a function is executed within an application 51, the application code 36 calls a discriminating API 38 with data related to the executed application. The discriminating API 38 is a module that is executable within the application 51 and is configured to recognize types of data that are to be monitored. The discriminating API is configured to recognize the data in advance by, for example, a mobile device operator or an IWM operator. When the discriminating API 38 recognizes data, it determines that the application 51 is to be monitored. More particularly, the discriminating API 38 determines that the recognized data produced by an executed function within an application is of a type or class of data that is to be monitored. In an exemplary embodiment, the discriminating API 38 is a dynamic link library (DLL) that is a shared code, and that is mapped into the process space of multiple applications. In other words, any one of multiple applications can call the discriminating API 38, and the discriminating API code is executed within the context of the calling application.

If the discriminating API 38 determines that data will be monitored, the monitoring API 39 stores the data in a memory 44 in the mobile device 51. The API 38 is, like the discriminating API 38, a module that is executable within the application 51. The memory 44 is the central information repository in the mobile unit 31 for all the attributes of application-specific information that is monitored from numerous applications. Any particular monitored data set can be collected from the memory 44 and transferred to the network appliance 10 using the wireless agent 55. The wireless agent 55 is configured, or supplemented with various plug-in modules 46, to collect and interpret the information from the memory 44 and to translate and communicate that information to the network appliance 10. Since a user may only want to review as little as one particular application execution, it is advantageous to have the memory 44 disposed within the mobile device 31 in direct communication with the monitoring API 39 rather than having all the application-specific data automatically transferred to the network appliance.

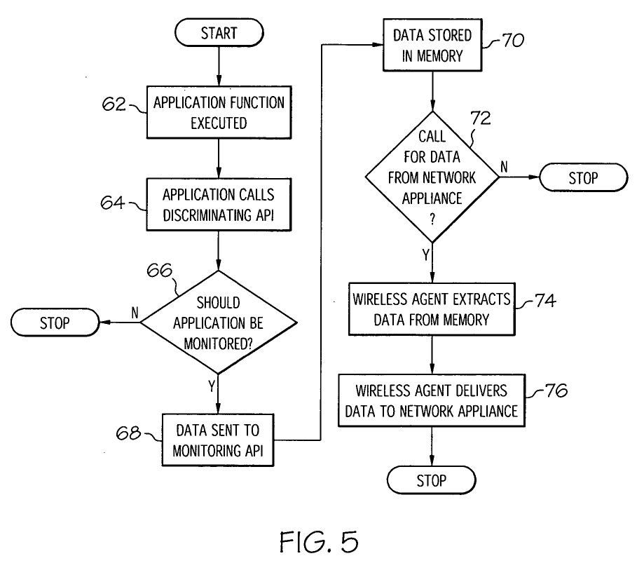

An exemplary method for monitoring an application using the second information collection pathway will now be described with reference to FIG. 5. The method is started at step 62 with the execution of an application function. The function can be anything that is predetermined to be potentially monitored, and execution of the function need not be performed successfully. For instance, the function can include a successful or unsuccessful attempt to read a magnetic strip.

After an application function is executed, a discriminating API that is a module within the application is called at step 64 when the application sends the API data related to execution of the application. As mentioned previously, the discriminating API is configured to recognize data that is to be monitored.

At step 66, the discriminating API determines that monitoring should be performed. If the data is not recognized by the API, the method stops. Otherwise, the API presents the data at step 68 to a monitoring API, which is also a module within the application. The monitoring API then stores the data in a memory at step 70. As mentioned previously, the memory is the central information repository in the mobile unit for all the application-specific information that is monitored from numerous applications.

After monitored data is stored in the memory, the method is stopped until the network appliance calls for transmission of the data, as shown by step 72. The network appliance can be programmed to automatically retrieve certain data sets from the mobile unit memory, or a user can prompt the network appliance to retrieve data as needed.

If the network appliance calls for transmission of the data, the wireless agent 55 extracts data from the memory at step 74. As mentioned previously, the wireless agent is configured, or supplemented with various plug-in modules, to collect and interpret the information from the memory and to translate and communicate that information to the network appliance at step 76. The method stops after data is transmitted to the network appliance.

In an exemplary embodiment the monitoring API 39 can be configured to automatically store continuous data related to execution of the application 51 in the memory 44 after the discriminating API 38 determines that the application 51 is to be monitored. Specifically, the after the discriminating API 38 determines that an application should be monitored, the monitoring API 39 will automatically retrieve data directly from the application code without having the data processed by the discriminating API 38. The monitoring API 39 will continue to store the application data until the discriminating API 38 determines that monitoring is not to be continued by failing to detect data that should be monitored.

It is again emphasized that the monitoring method described with reference to FIG. 5 is carried out in an exemplary embodiment without using a system-level API 32 such as a device driver API. Although system-level monitoring using process-independent methods is beneficial for many purposes, the information that is being monitored is inherently abstracted from a connection to a system-level application that is processing or otherwise using the information. Consequently, system level monitoring typically provides generic information and not specific or contextual information about how a specific application is performing. In contrast, since the exemplary method outlined in FIG. 5 collects information by incorporating a monitoring API into an application and directly extracting from the application code, detailed sets of information is made available within the mobile device memory 44 and ultimately to the network appliance 10 as needed. When combined with the system-level monitoring, the application-level monitoring can provide full visibility into the operation of a mobile device.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method of monitoring an application in a mobile device that is a component of a network, comprising the steps of:
sending data related to execution of the application to a discriminating application programming interface (API) that is a module executable within the context of the application, and is configured to determine whether the data is of a type that is to be monitored; and
monitoring data related to execution of the application, using a monitoring API that is a module executable within the context of the application, if the discriminating API determines that the data is of the type that is to be monitored.

2. The method according to claim 1, further comprising the step of:
storing the data being monitored in a memory included in the mobile device.

3. The method according to claim 1, wherein the discriminating API is a dynamic link library that is shared by a plurality of applications, and that is mapped into the process space of each of the plurality of applications.

4. The method according to claim 1, further comprising the step of:
automatically storing additional data related to execution of the application in the memory using the monitoring API after the discriminating API determines that the data is of the type that is to be monitored.

5. The method according to claim 3, further comprising the step of:
automatically ending storage of additional data related to execution of the application in the memory if the discriminating API fails to determine that the data is of the type that is to be monitored.

6. The method according to claim 2, further comprising the step of:
transmitting the data stored from the memory to a network appliance that includes include an integrated wireless management system and a processor.

7. The method according to claim 6, wherein the network appliance processor is configured to automatically call for transmission of the data from the mobile device.

8. The method according to claim 6, wherein the network appliance processor is configured to call for transmission of the data from the mobile device upon receipt of a user request.

9. A wireless networking system, comprising:
a network appliance having an integrated wireless management system, and a processor; and
at least one mobile device, comprising:
an application module,
a discriminating application programming interface (API) that is a module executable within the context of the application and configured to determine whether the data is of a type that is to be monitored,
a monitoring API that is a module executable within the context of the application and configured to extract the data if the discriminating API determines that the data is of the type that is to be monitored, and
a wireless agent configured to extract and transmit the monitored data to the network appliance.

10. The wireless networking system according to claim 9, wherein the mobile device further comprises a memory in communication with the application and configured to receive and store the monitored data from the monitoring API.

11. The wireless networking system according to claim 9, wherein the discriminating API is a dynamic link library that is shared by a plurality of applications, and that is mapped into the process space of each of the plurality of applications.

12. The wireless networking system according to claim 10, wherein the monitoring API is configured to automatically store additional continuous data related to execution of the application in the memory after the discriminating API determines that the data is of the type that is to be monitored.

13. The wireless networking system according to claim 12, wherein the monitoring API is further configured to automatically end storage of data related to execution of the application in the memory if the discriminating API fails to determine that the data is of the type that is to be monitored.

14. The wireless networking system according to claim 9, wherein the network appliance processor is configured to automatically call for transmission of the data from the mobile device.

15. The wireless networking system according to claim 9, wherein the network appliance processor is configured to call for transmission of the data from the mobile device upon receipt of a user request.

16. A wireless networking system, comprising:
a network appliance having an integrated wireless management system, and a processor; and
at least one mobile device, comprising:
an application module that includes means for receiving data related to execution of the application and determining whether the data is of a type that is to be monitored, and means for extracting the data if the data is of the type that is to be monitored, and
means for extracting and transmitting the monitored data to the network appliance.

17. A program product for monitoring an application in a mobile device that is a component of a network, the program product comprising:
computer readable instructions stored on the mobile device and executable to:
send data related to execution of the application to a discriminating application programming interface (API) that is a module executable within the context of the application, and is configured to determine whether the data is of a type that is to be monitored; and
monitor the data, using a monitoring API that is a module executable within the context of the application, if the discriminating API determines that the data is of the type that is to be monitored.

18. The program product according to claim 17, wherein the computer readable instructions are further executable to store the data being monitored in a memory included in the mobile device.

19. The program product according to claim 18, wherein the computer readable instructions are further executable to automatically store additional data related to execution of the application in the memory using the monitoring API after the discriminating API determines that the data is of the type that is to be monitored.

20. The program product according to claim 19, wherein the computer readable instructions are further executable to automatically end storage of additional data related to execution of the application in the memory if the discriminating API fails to determine that the data is of the type that is to be monitored.
